(19) United States
(12) Patent Application Publication
(10) Pub. No.: US 2012/0276935 A1
(43) Pub. Date: Nov. 1, 2012

(54) Method for constructing, implementing, incorporating, and executing passenger tones through the conduits of systemic behaviors of operations, through, removable media device, and computer architecture of hardware and software for transfer, through, the conduits of the systemic behaviors of application software and framework for communications, through a conduit digital device

(76) Inventor: Caroline Elizabeth Coleman, Saint Cloud, FL (US)

(21) Appl. No.: 13/371,393

(22) Filed: Feb. 11, 2012

Related U.S. Application Data
(60) Provisional application No. 61/479,867, filed on Apr. 28, 2011.

(51) Int. Cl. H04W 4/14

(52) U.S. Cl. 455/466

(57) ABSTRACT

A method for constructing, implementing, and executing passenger tones. Comprising of recorded digital audio files from a conduit removable media device digital audio recorder for incorporation of concatenation into a conduit for transmission called the sms text messaging phone feature. In a sub directory folder in a communication networks computer of passenger tones. Retrieved through the software framework for communications of a digital device. Retrieved as a remote upload by the succeeding add file client of the sms text messaging phone feature as an attachment through concatenation. Transmitted through communications networks protocols from computer platform to computer platform, through the conduit of computing platform to computing platform of hardware and software architecture to relay instant audio upon charge through the conduit digital device called a cellular phone; from call originator to destination users cellular phone, from digital device to digital device as a feature.

### CROSS REFERENCE TO RELATED APPLICATIONS

Provisional Patent Application No. 61/479,867 filed on Apr. 28, 2011 is the prior recognized version of this application that has been altered to a different standard referencing its subject matter for this Utility Patent.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The SMS Text Messaging cellular phone feature typically exhibit's the sending and receiving of personal messages via cellular phone, from call originator to destination user. The options found in the mobile phone offer the feature to send the messages that consists of the typical text characters. The SMS Text Messaging cellular phone feature currently has the capabilities of sending images, video, and sound to be uploaded to a cellular phone to personalize to the carriers customizations notification's of different kinds The SMS Text Messaging phone feature includes 26 letters of the alphabet A to X and 10 numerals. Passenger tones advances current forms of SMS capabilities by allowing the uploading of sound attachment files to immediately upload through the application software in a cellular .phone without the user manually uploading them from a saved file to listen to. Passenger tones instantly plays the sound as soon as the message is received. This changes the current preference of the cellular phone users default ringtone or musical tone to the tone being sent from the originator cellular phone carrier. Whichever the musical salutation may be it is picked by the originator for the destination user to hear as soon as it is received. The destination user will not have to upload this file to hear it. It immediately plays the salutation for them to hear. The preference of the passenger tone is the choice of the person making the call. If I intended for you to hear “Mary had a little Lamb” and it was my preference than I would attach this file to my text message being sent to you. You would instantly hear on your phone “Mary had a little Lamb” instead of your ringtone preference or default musical tone as soon as you received the message.

The SMS Text Message is sent from a mobile phone that transfers to the Short Message Service. The Short Message Service uses the store and forwarding option. The SMSC Short Message Service Center routes the SMS messages and regulates the process. The message is stored if the message was unable to go through and is sent again at a later time. SMS sends a status report to the sender to inform them of the delivery attempt. SMS Text Messages can be sent with out the use of a mobile phone instead being sent by the SMS gateway and other digital device.

The SMS Text Messaging cellular phone feature has many great additions but needs to be upgraded to a better personalization that has a more advanced addition. It is so neat to send and receive images and ringtones, and messages but these features don't offer the enhanced possibilities that the new latest 4G and Greater technology have to offer. Currently, the cellular phone carrier chooses how their phone looks and sounds. Optimally, the SMS Text Messaging cellular phone feature needs to be upgraded to a new standard that can be done by the addition of passenger tones cellular phone features optimization for advancement by giving the cellular phone owner the choice to send the expulsion of a musical tone to the cellular phone receiver that he or she chooses that is a succeeding add file client attachment to the SMS Text Messaging cellular phone feature, that serves as a conduit for transmission.

### BRIEF SUMMARY OF THE INVENTION

The present invention features a method for constructing, implementing, incorporating and executing digital audio recordings of files into the predetermined conduit of transmission which succeeds as the sms text messaging phone feature. The approach includes initializing the communication networks modem for relay of transmission by way At command and command line structure of digital audio attachments for relay, that are executable by way of construction, through a computer utility software application that transmutes through the conduit of computer architecture of hardware and software, through, the conduit of a digital cellular device.

The audio files are those that are created uploads from a digital audio device called a digital audio recorder as a device conduit, that is a removable media device that collects sounds that consist of tones, that pass through the device while being manipulated into a digital binary template. The audio files upload through the audio software framework of the computer operating system, that is a collection of vibrating intrinsic and arbitrary tones from a natural and synthetic source derived from the produced sound by a rapid variation in the average density or pressure of air molecules that are above and below the current atmospheric pressure. The sound is perceived as sound as the pressure fluctuations cause vibrations. Sound waves are produced by the vibrating body of earths atmosphere and rotation. The vibrating sound source causes a disturbance to the surrounding air molecules; this causes them to bounce off each other with a force that is proportional to the disturbance. The energy of the interaction of the force disturbance creates ripples of more dense that is higher pressure to less dense that is lower pressure of air molecules. Rising above and below atmospheric pressure. Compression occurs when the molecules are pushed together and when they are pulled apart causes rarefaction. The oscillation back and forth of the pressure produces the sound waves. The sound waves create tones that are carried by the vibrating waves. When uploaded into computer software architecture for audio; translation of digital data and formatting of the files occurs into the default programming language, and are stored in the internal directory structure and the internal file structure of the local disk c hard disk drive, that is a primary directory of the computer operating system.

Another aspect of the invention is the method for incorporating the construction of “behaviors” of the At command and command line structure that realize the internal directory structure and internal file structure, that dictates the capacity of the interaction between both passenger tone and its ability to finalize through the systemic operations of software manipulations of the utility software, as the tones pass through the conduits, to be stored for retrieval and execution; to create its divergence for its conventional path through the communications computer architecture as a conduit. The data scheme is received when the behaviors are conclusive though the conventional path and prompts the selections that are to be made to the desired appropriation depending on the data entered into the communications computer operating system to adhere to protocols.

The rendered audio files are retrieved through the application framework of the digital device called a cellular phone, using the sms text messaging cellular phone features succeeding add file client, that enables file attachment by concatenation of the data scheme. The attached file of passenger tones is sent with the text message, to transfer to the destination users cellular phones application software for communications, whose audio software relays the file, enabling the files command line structure to execute the file that relays audio expulsion by charge through a digital device. The passenger tones audio recorded stream of binary numbers is converted back to analog that is amplified and fed to the speaker of the digital device called a cellular phone, through, the audio software application of the cellular phone carriers communication networks communications software.

### BRIEF DESCRIPTION OF THE SEVERAL VIEWS OF THE DRAWING

FIG. 1. Is a flowchart diagram of the operations used to initiate passenger tones, that executes passenger tones as a cellular phone features behavior, through, implementing, incorporating, and constructing through the conduit computer architecture of hardware and software with many implementations of the present invention as described in the following:

FIG. 2. Is a flowchart diagram of the operations used to initiate the execution of passenger tones as a cellular phone feature through the conduit sms text messaging cellular phone feature for network to network communications through the computer architecture of hardware and software with many implementations of the present invention.

### DETAILED DESCRIPTION OF THE INVENTION

A method that is of passenger tone herein of the invention, with implementations of communications from network to network protocols that define a language of rules and conventions for communication between network devices; thorough, a digital cellular device to a digital cellular device called a cellular phone; from computer architecture to computer architecture of computing platform to computing platform, capable of file attachment through concatenation of Atstrings of a data scheme, accessed by an sms text messaging's succeeding add file client to the sms text messaging cellular phone feature as a conduit for transmission.

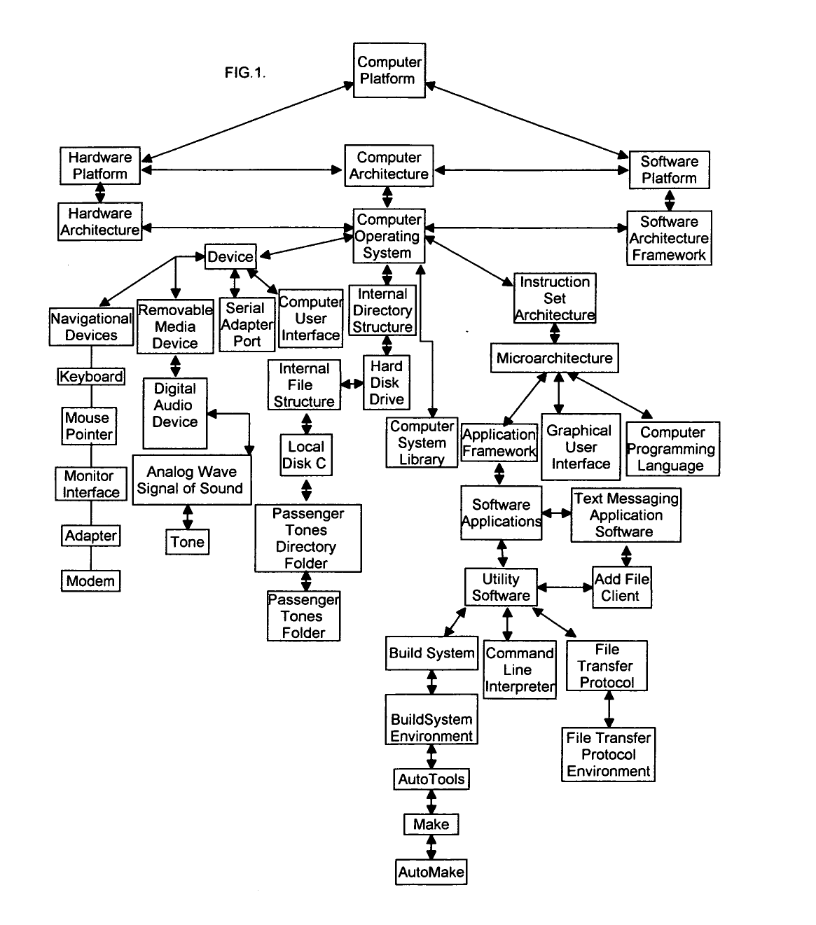

FIG. 1 Is a flowchart diagram of the operations used to initiate passenger tones, that executes passenger tones as a cellular phone features behavior, through, implementing, incorporating, and constructing through the conduit computer architecture of hardware and software with many implementations of the present invention as described in the following:

The method of passenger tones is programmable by one who is skilled in the art into the conduit computer architecture that is equipped with hardware architecture and software architecture components, that are utilized as devices of the systems design: computer architecture, computer operating system, computer programming language, computer user interface system, computer system libraries, and computer graphical user interface; for the developing of input and output of data scheme, through, a platform for the computing of instruction set architecture and microarchitecture for the data processing of commands in the formation of passenger tones programming language.

The method of passenger tones demands keyed entry and selection by one who is skilled in the art, into, the computer architectures software architecture by using the connected computer hardware components: device monitor interface for viewing the images of text on the interface or screen of the monitor, input device mouse pointer for making selections through the application software viewed through the monitor interface, and the typing of text or numerals of information into the computer for use by way of input device keyboard, and selection by way of aforementioned graphical user interface with said device mouse pointer; into the software framework architecture, that is the application software used by the computer, that is the microarchitecture that stores the directories passenger tones needs to implement; enabling its process into the root directory local disk c, that is the hierarchy of directories within the software's architecture, that is non-volatile storage device for digital data where data is encoded magnetically into a file system for storing and organizing computer files and their data for retrieval and execution.

The method called passenger tones is called object orientated programming and needs to be implemented inside of the root directory local disk c as its own directory, into, its own folder named passenger tones. The folder for passenger tones is created by aforementioned selection, by entering into the aforementioned computer architecture, and into the computers software framework architecture, and locating the local disk c by navigation through said software framework architecture that is engineered into each computer as a main functioning component. The computers software framework architecture enables navigation through the system design of the computer using navigation tools developed in the software architecture to implement computer programming and developing of new software for use, enabling the functionality of passenger tones within the computer operating system, with system navigational devices mouse pointer, keyboard, and user interface.

The method called passenger tones uses its directory folder as a container for the passenger tones sub folder and files stored inside of it called the internal directory structure and file structure; making passenger tones contents a sub directory located in the directory passenger tones. Passenger tones sub folder and files are created inside the passenger tones directory folder using the aforementioned navigation tools of the system design to enable the implementation of passenger tones functionality with the computer operating system. Passenger tones files are blocks of arbitrary information, or resource for storing information which is available to software architecture of a computer program and is usually based on some kind of durable storage. The aforementioned sub folders of passenger tones contain files that consist of passenger tones.

The method called passenger tones implements the digital audio recordings of a digital audio device as a conduit removable media device called an audio digital recorder that makes digital abstract templates of an original sound by collecting tones of sound and placing them into digital audio recordings of data from the analog signal of sound that is converted into a stream of discrete binary numbers, representing the produced sound that consists of a rapid variation in the average density or pressure of air molecules that are above and below the current atmospheric pressure. The sound is perceived as sound as the pressure fluctuations cause vibrations. Sound waves are produced by the vibrating body of earths atmosphere and rotation. The vibrating sound source causes a disturbance to the surrounding air molecules; this causes them to bounce off each other with a force that is proportional to the disturbance. The energy of the interaction of the force disturbance creates ripples of more dense that is higher pressure to less dense that is lower pressure of air molecules. Rising above and below atmospheric pressure. Compression occurs when the molecules are pushed together and when they are pulled apart causes rarefaction. The oscillation back and forth of the pressure produces the sound waves. The sound waves create tones that are carried by the vibrating wave. Uploading occurs of each individual digital audio recording of data; into the aforementioned sub directory folder as the passenger tone passes from one conduit to the other conduit. The files for passenger tones can only store bits, that is a binary digit, that is the basic unit of information in computing and telecommunications, that is the amount of information that can be stored by a digital device or other physical system. The aforementioned digital audio recordings from the conduit removable media device called the digital audio recorder, uses, a digital adapter, that is a connector cord that is plugged into the port of the digital audio recorder, and extends to the serial port of the aforementioned computer operating system, as a hardware component that streams media from port to port, for the transfer of the audio binary digital recorded data into the application software framework architecture, for audio, of the computer operating system. The system uploads the audio binary digital recordings and is formatted automatically by the default audio settings in the software framework of the computing platform of the software's applications in the computers software architecture, that is predetermined when engineered by the developing programmer for use. The prompting option to save the files will display on the device monitor of the computers interface and the selection of local disk c directory, by way of navigation to save the file is located and selected from the scrolling list of directory save options. The sub directory passenger tones folder is selected. Located in the local disk c directory using said navigational devices, that directs the default audio software to save the audio binary digital recordings as files, into, the sub directory passenger tones folder. Passenger tones files are saved individually and retrieved individually.

The method called passenger tones object orientated programming language implements the system library of the predetermined programming language developed in said hardware and software platform to adhere to every protocol, amendment and conformance of standard used by the computer engineers default settings of the aforementioned computer of use; to enable the functionality of passenger tones as the present invention.

The method called passenger tones implements the installed build system of autotools computer software framework, that is a suite of computer programming tools designed to assist in making programs and source code packages for computer software, of said computer for use; to enable portability of the program by using a build environment that passenger tones implements, to enable the cross platforming from computer system to computer system. Passenger tones uses said navigational devices to make selections of the autotools of the build system in the build environment of software application framework. The build system of computer software is accessed in the root directory local disk c of said computer, where it is stored in its directory folder for use and retrieval. Herein, the aforementioned autotools reference the autotools of the build system, that are in the build environment of software application framework, that is the build system used to enable passenger tones.

The method called passenger tones digital audio binary recordings of digital data, located in their sub directory folder, are uploaded by said build system into said build environment, using said navigational devices to make selections inside said build environment, to enable the configuring of each recording by one who is skilled in the art. The autotools are accessed to enable passenger tones digital audio binary recordings of files to be manipulated by the configurations of the build systems autotools for implementations of object orientated computer programming of passenger tones.

The object orientated computer programming of passenger tones, utilizing said autotools to configure the digital audio binary recordings, implements, the autotool called buildautomation selection, to enable the automatic building of passenger tones directory and library of sub folders and files into a computer program. The one skilled in the art is to use the build automation tool and autotools to construct many implementations of the present invention.

The one skilled in the art will implement other prompted configurations of the installed build system as the buildautomation autotool function prompts the user to choose between certain personalization criteria to enable passenger tones to adhere to the managing of the software's design for operation within the build system environment. The prompts are assessments that the framework of the build system rely on, to enable construction of the program from start to finish because it is an automatic build autotool; that has its own implemented manipulations as it is creating a functional software component. The buildautomation autotool will represent the organization of the autotools used for the creation of passenger tones, in its own organization, at its systemic value of the procedure that creates its own dynamic.

The one skilled in the art implements the autoscan program autotool selection of said build system environment, then, accessing the files called passenger tones from said directory with the autoscan program, to configure the source files that are the passenger tones sub directory files of recorded digital audio; enabling the searching of common portability problems, creating a new passenger tones file of a configure scan, which, is preliminary configure ac for the enabling of passenger tones computer program; and checks the possibly existing configure ac file for passenger tones, for completeness, to make sure that the files are configured correctly.

The one skilled in the art implements the autoconf selection autotool of said build system environment by using said navigational tools to make selections. The passenger tones saved configure ac files in the sub directory folder are selected by the autoconf autotool after the autoscan is complete, that takes the source code called passenger tones, characterized, by the configure ac files of passenger tones libraries of files, to implement the configurescript autotool of said build system environment, derived from the passenger tones libraries and the computer operating systems predetermined default system libraries, before, compiling from its source code to configurescript the passenger tones files, by using said navigational tools to make selections in said build system environment of the configurescript selection before creating the makefiles called passenger tones.

The one skilled in the art implements the make utility of said build system in said build system environment, that automatically builds executable programs and libraries from source code by reading files called makefiles, that derive from the configurescript. The aforementioned configurescript enables the one skilled in the art to implement the automake selection autotool of said make utility of the build system environment, to, autobuild passenger tones makefiles. To create the makefiles; the one skilled in the art accesses the passenger tones saved files of configurescript, through, the build systems environments automake autotool, making selections with said navigational tools of the files from their sub directory location.

The aforementioned implementation of automake autotool construct's a command line of each passenger tone makefile, that implements the command instruction of audio expulsion by charge, that the one skilled in the art constructs by using said matched system libraries gathered by the aforementioned configurescript library of files located in sub directory passenger tones folder, that contain the commands of the predetermined command language in the computer operating system, engineered by the computer developer, implemented, as the default command settings that are instruction set architecture of commands for the system to enable audio expulsion by charge. The configurescript library of said matched libraries is accessed by said navigational tools from the saved selection in the passenger tones directory folder. The passenger tones files in its present state are considered execution files, and passenger tones in its present state is a computer program comprising of built execution files of audio digital data. The passenger tones files in its present state are individual Atstring literal execution files of command string audio digital data scheme.

The one skilled in the art will implement the ac configuration of configuration headers of said build systems autotools by using the autoheader selection autotool during the construction of said automake for passenger tones for implementation of the sms text messaging At commands, that enable the passenger tones makefile to initialize a modem. The At commands are located in the aforementioned configurescript library of files containing commands. The header enables the initialized modem to direct the passenger tones execution file to the file transfer protocol environment, that encodes and decodes the Atstring literal data scheme execution file, enabling preparation of the file for interpretation and charge.

The one skilled in art is to save each new version of passenger tones files into the sub directory passenger tones, as each autotool specified herein as implementations of the present invention are utilized. Each autotool creates a different variation or version of passenger tones files, and data scheme, as they are advanced through the process of creation. Each variation of passenger tones files is to be organized within its sub directory of folders, and are to be subjugated categories after each autotool is implemented by naming the sub directory folder with the autotools name in reference to the passenger tones files thereof

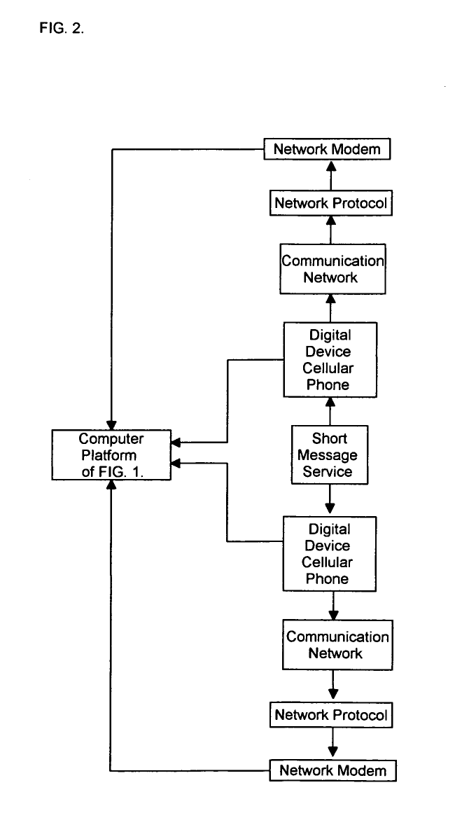

FIG. 2. Is a flowchart diagram of the operations used to initiate the execution of passenger tones cellular phone feature through the conduit sms text messaging cellular phone feature for network to network communications through the computer architecture of hardware and software with many implementations of the present invention as described in the following:

The one skilled in the art accesses the software application framework of an information appliance, that is a cellular phone, of, the communication networks communications software architecture, of, their computer architecture for communications; to enable the execution of passenger tones from the digital device called a cellular phone to a digital device called a cellular phone, from network protocol to network protocol, from computer platform to computer platform, from communication software to communication software, from network modem to network modem, from computer architecture to computer architecture; by locating the new text message option of the cellular phone as an option to select. When the call originator designates the option to send a text message to the destination users cellular phone; the text messaging software will be prompted to appear on the graphical user interface where the text message is entered, and, the send to address is entered for the intended receiver to receive the message. The succeeding add file option of the sms text messaging cellular phone feature client is selected to enable file attachment of the passenger tones file, that is a concatenated data scheme, to, the data scheme of the text message being sent, that join the character strings together to make one data scheme called an Atstring literal, due to, passenger tones being a representation of a string value within its source code as a computer program. The passenger tone is selected after the succeeding add file option is selected and the scroll of directories appears on the user interface, and the local disk c is to be selected, and the sub directory menu opens where passenger tones directory is located and selected. The passenger tone is selected and is then attached to the text message when prompted, and the message is to be sent after attachment by selecting the send message option of the text message.

The method of passenger tones travels from digital cellular device to digital cellular device by way of conduit through the sms text messaging phone feature, after, the send option of the text message is prompted and transfer of the passenger tones from network protocol to network protocol is initiated. As a conduit; the text message with the passenger tones attachment when sent from the call originator to the destination user is sent to the smsc or short message service center that is a network element in the cellular network, where, a store and forwarding of the text takes place. The smsc regulate the way the text messages are processed, when to store, and when to forward the message. Upon retrieval of the incoming text message by the destination users telecommunications network, is alerted of the transferring from network protocol to network protocol by way of modem. The At commands of the text messaging signal to the destination users modem command to answer the incoming message from the signal path protocol of the call originator. As the transfer of the text message processes through the destination users computer operating systems application software architecture, the conduit, enables passenger tones file attachment to execute through the destination users computer operating systems application software directly following the text message. The passenger tones file is an execution file that has behaviors that enable the processing of the execution file that comprise of: a command line structure; that initiates upon transfer through the remote file transfer protocol environment after login; of the destination users computer operating systems software application architecture, after, the header of the command line initializes the modem directly after the text message data scheme transfers through. The remote file transfer protocol environment is the standard network protocol used to transfer files from one host to another host over the internet. The environment is an interactive command line tool implementing standard commands and syntax that encodes and decodes the passenger tones files, and sends it to the command line interpreter that interprets the execution file, and executes the commands as they are instructed for relay of instant audio expulsion by charge through the digital cellular device upon remote uploading, utilizing, the audio software framework to convert the recorded stream of binary numbers to analog that is amplified and fed to the speaker of the digital device called a cellular phone; of the desired sound of the execution file called passenger tones.

The method called passenger tones is a passenger tone as it passes through and utilizes the conduit of a digital device of computer architecture equipped with computer hardware and software framework with applications, as it utilizes the conduit called a cellular phone, as it utilizes the conduit called a digital audio device, as it utilizes a digital device to enable transmission by attachment to the succeeding digital device, to carry the passenger tone through a systemic operation of a digital device, to transmute through transmission from a digital device to a digital device using the text messaging cellular phone feature, to transmute through signal to signal of a digital device in file format as an add file for a succeeding add file client, to a communication protocol from a communication protocol, manipulated through the systemic movement from digital device to digital device that transmutes through charge. Creating passage; enabling the tone to succeed through a digital device to omit sound as an analog converted signal of vibrating wave. It is relayed through the manipulative operations of the succeeding conduit digital device as an audio expulsion of sound that is a tone.

1. I claim a method for the incorporating and the executing of passenger tones through a conduit of computer architecture, through a conduit removbale media device digital audio recorder, through a conduit digital device of cellular phone technology for the preferred embodiment further comprising the steps of,
the utilizing of conduit computer architecture of computers systems design, instruction set architecture and microarchitecture means a specification of the computational, communication and data storage elements for the data processing of commands in the hardware and software computer architecture and framework for the formation of passenger tones programming language and source code, and software application framework for the execution of passenger tones through conduit computer operating system for creation and storage of passenger tones into root directory c drive of directory folders, sub directory folders and files of passenger tones,
the configuring of the individual files in the sub directory folder of passenger tones of uploaded digital audio recordings from the audio storage hardware and software in conduit removable media device digital audio recorder, into, the application software framework of the computer operating systems audio software framework, for creation of digital audio files of passenger tones recorded as the passenger tones system library consisting of manipulated, recorded variations of intrinsic and arbirary tones through passage,
the selecting of the digital audio recordings of passenger tones of the passenger tones library of files for subject orientated computer programming means the computer programming of the advocation of a classification that describes objects into subjects for composition for methods valued as the instrisic nature of the subject for use as a computer program, and accessing the application software framework to make data entered computations through the application software frameworks succeding installed build system of auto tools of application software utility, to configurescript means an automated method of generating makefiles before compiling for the software system to use for execution of the program built of the buildsystem for the make utility, to create makefiles from passenger tones digital audio files, to make the files of passenger tones executable, to become an executable program through passage
the construction of passenger tones into single command lines of data through the make utility of said build system for concatenation means to arrange strings of characters into a chained list of data computations, by the succeeding add file client of the sms text messaging phone feature for remote upload means a copy of the original content of the file for add file attachment to the conduit sms text messaging phone feature, for transmission of passenger tones files, for tone relay when concatenation of file to sms text messaging conduit is achieved,
the execution of the single command line of passenger tones through conduit digital cellular device to a digital cellular device called a cellular phone, transferring from the originator cellular phone callers internet host to the destination users cellular phones internet host, from communications network protocols to communications network protocols that define a language of rules and conventions for communication between network devices, from computer architecture to computer architecture of computing platform to computing platform that initiates the destination users networks modem to answer the call, relaying audio instantly through transfer upon charge from the tones of digital audio recordings of passenger tones.

2. I claim the method of claim 1 wherein said conduit of computer architecture of computer operating system and instruction set architecture, and microarchitecture is a programmable machine that receives input, stores and manipulates data, and provides output in a useful format that regulate the ways application software programs use its computer hardware and individual components to process, and the way that users control the computer for storage and operation, and is the central processing unit for the creating of passenger tones further comprising of,
the executing of the method of passenger tones utilizing the computing computer platforms of computer architecture of the systems design further comprising of,
computer programming language, computer user interface and graphical user interface, computer system libraries and navigational devices further comprising of, input device keyboard, input device mouse pointer, viewing device monitor, device adapter, and device modem,
wherein said method of passenger tones demands keyed data entry means the typing of the text or numerals of information into computations into a computer by one who is skilled in the art using input device keyboard for implementation into the root directory c drive means the first or top most directory in a hierarchy or starting point for creation and storage and operation, and the c drive is a hard disk drive that is a non volatile storage device utilized by passenger tones found in a computer for digital data where data is encoded magnetically into a file system that is a method for storing and organizing computer files and their data for retrieval and execution,
wherein said files are of a computer folder that is a virtual container within a digital file system in which groups of computer files and other folders can be stored and organized contains passenger tones,
wherein the object orientated programming language of passenger tones implements the programming language developed in the computing platform of hardware and software in the computer architecture developed in the computer at the computers functional state by one who is skilled in the art,
wherein passenger tones object orientated programming language implements the system library of the programming language to adhere to every protocol, amendment and conformance to standards,
wherein said files can only store bits that is a binary digit that is the basic unit of information in computing and telecommunications that is the amount of information that can be stored by a digital device or other physical system, that is the recording value of the removable media device audio digital recorder.

3. I claim the method of claim 1 wherein said configuring uses a removable media device audio digital recorder that is a device that retrieves, collects, saves and transfers sounds from vibrating waves and places them in digital audio recordings of data from the analog signal of sound that is converted into a stream of discrete binary numbers, representing the produced sound derived by a rapid variation in the average density or pressure of air molecules that are above and below the current atmospheric pressure where the sound is perceived as sound as the pressure fluctuations cause vibrations, wherein the sound waves are produced by the vibrating body of earths atmosphere and rotation, wherein the vibrating sound source causes a disturbance to the surrounding air molecules, wherein this causes them to bounce off each other with a force that is proportional to the disturbance, wherein the energy of the interaction of the force disturbance creates ripples of more dense that is higher pressure to less dense that is lower pressure of air molecules; that is a rising above and below atmospheric pressure, wherein compression occurs when the molecules are pushed together and when they are pulled apart causes rarefaction, wherein the oscillation back and forth of the pressure produces the sound waves, wherein the sound waves create tones that are carried by the vibrating waves being air pressure that is audio, through time, making recorded digital abstract templates of the original sound and tone and further comprising the method of passenger tones,
wherein said digital audio recordings are passenger tones from the tone of vibrating waves finding passage through a device conduit's device manipulation as its conventional path,
wherein said digital audio device uses the removable media device adapter that is the connector cord from said digital audio device to the serial adapter port of the hardware computer architecture for the transfer of audio binary digital recorded data into application software by uploading the digital audio recordings of data into the physical computer system,
wherein said uploads of digital audio recordings of data are installed into the sub directory passenger tones folder as files and saved as audio files of audio binary digital data, through the software platform of said computer, that upon uploading automatically, implements, formats, codes, and decodes each digital audio recording through transfer from removable media device adapter connected to digital audio recording device, according, to the default audio settings in the software platform,
wherein said files are configured through the build system of autotools of a suite of programming tools designed to create computer programs and other software developing tasks through its environment, each file individually configured to implement the compiling of them as an executable computer program of passenger tones with implementations further comprising the method passenger tones,
wherein said configuring of passenger tones through the build system of autotools implements each individual file to enable portability of cross platforming through computer architecture,
wherein one skilled in the art will manually construct the object orientated computer programming of passenger tones into single executable command lines by implementing the autotool called buildautomation of the build system,
wherein the configuring of passenger tones files uses the autoscan program of the build system environment to configure the source files that are passenger tones files in the primary directory folder of passenger tones, that enables the searching of common portability problems and creates a file of a configure scan which is a preliminary configure file for the enabling of passenger tones computer program, and checks the possibly existing configure file for passenger tones for completeness,
wherein said configure file of passenger tones demands the configuration of configuration headers to implement the at commands of the sms text messaging, to initialize a modem,
wherein the contents of said configure file of passenger tones that characterizes passenger tones source code is used by the autoconf of the build systems auto tool, to generate a configurescript from the systems libraries in the application software framework with the passenger tones libraries before compiling from its source code,
wherein passenger tones source codes are used by the make utility of the build system that automatically builds executable programs and libraries from source code by reading files called makefiles that derive from the configurescript, wherein the configurescript enables the automake auto tool of the build system to autobuild passenger tones makefiles with further comprising of the method of passenger tones,
wherein passenger tones uses the automake autotool to construct a command line of each passenger tone makefile that implements the instruction of audio expulsion by charge upon remote upload of the file through a digital cellular device to a digital cellular device of cellular phone technology, transferring from the originator cellular phone callers internet host to the destination users cellular phones internet host, communications network protocols to communications network protocols, from computer architecture to computer architecture of computing platform to computing platform, from modem to modem,
wherein the command lines header uses the at commands of the sms text messaging phone feature to enable modem initialization in the destination users cellular phones networks modem to interact between modems internet host to internet host to prepare the modem to answer the message that it is receiving,
wherein the passenger tones makefile of passenger tones file is retrieved by an sms text messaging phone features succeeding installed add file client that enables the concatenation of passenger tones file to the sms text message as a computer programming atstring of characters in a sequence of elements that enables add file attachment of passenger tones that is considered a character string of data that uses the sms text messaging phone feature as a conduit for transmission that enable the specification of passenger tones method to be a passenger tone,
wherein the transmission of the passenger tones utilizing said conduit, upon retrieval by the destination users communication networks software application framework for their cellular phone, and after the destination users communication networks modem initializes and prepares their computer platform for the incoming file, is directed to the file transfer protocol environment that implements the passenger tones file into the computer system and computer software framework, to be interpreted and sent to the command line interpreter that executes passenger tones through the audio application software platform for instant relay of audio expulsion by charge through said digital cellular device, of the sound of the passenger tones file, after the audio recorded stream of binary numbers is converted back to analog that is amplified and fed to the speaker of the digital audio device called a cellular phone,
wherein passenger tones is a passenger tone as it utilizes the conduit of a digital device of computer architecture equipped with computer hardware and software framework with applications, as it utilizes the conduit called a cellular phone, as it utilizes the conduit called a digital audio device, as it utilizes a digital device to enable transmission by attachment to the succeeding digital device, to carry the passenger tone through a systemic operation of a digital device, to transmute through transmission from a digital device to a digital device using the text messaging cellular phone feature, to transmute through signal to signal of a digital device in file format as an add file for a succeeding add file client, to a communication protocol from a communication protocol, manipulated through the systemic movement from digital device to digital device that transmutes through charge, creating passage, enabling the tone to succeed through a digital device to omit sound as it is relayed through the manipulative operations of the succeeding conduit digital device as an instant audio expulsion of sound that is a tone.
